(19) United States
(12) Patent Application Publication
(10) Pub. No.: US 2013/0178110 A1
(43) Pub. Date: Jul. 11, 2013

(54) PLUG CONNECTOR

(71) Applicants: Bao-Geng XIE, Dong-Guan (CN); Wei-Hong LIAO, Dong-Guan (CN); Yin-Lung WU, New Taipei City (TW); Ming-Chiang CHEN, New Taipei City (TW)

(72) Inventors: Bao-Geng XIE, Dong-Guan (CN); Wei-Hong LIAO, Dong-Guan (CN); Yin-Lung WU, New Taipei City (TW); Ming-Chiang CHEN, New Taipei City (TW)

(73) Assignee: Cheng Uei Precision Industry Co., LTD., New Taipei City (TW)

(21) Appl. No.: 13/345,672

(22) Filed: Jan. 7, 2012

(51) Int. Cl. H01R 24/68

(52) U.S. Cl. 439/660

(57) ABSTRACT

A plug connector includes an insulating housing, a plurality of first terminals, a plurality of second terminals and an artistic terminal which are inserted forward in the insulating housing. The first terminal has a first soldering portion bending sideward and then extending rearward at a rear end thereof. The second terminal has a second soldering portion bending towards one side opposite to the first soldering portion and then extending rearward at a rear end thereof. A positioning bracket is mounted to a rear of the insulating housing and has a base body with a plurality of positioning fillisters apart opened in a top surface thereof. The first soldering portions and the second soldering portions are positioned in the positioning fillisters respectively. A metal shell sheathes the insulating housing.

### BACKGROUND OF THE INVENTION

1. Field of the Invention

The present invention relates to a connector, and more particularly to a plug connector.

2. The Related Art

As the development of electronic and communication technology, plug connectors are widely used in electronic products. A traditional plug connector includes an insulating housing, a plurality of terminals and a positioning bracket. The insulating housing defines a plurality of terminal grooves each extending along a front-to-rear direction to penetrate through a back of the insulating housing. The terminals include a plurality of first terminals and a plurality of second terminals of which each has a soldering tail, wherein the terminals are disposed in the terminal grooves of the insulating housing respectively with the soldering tails stretching behind the back of the insulating housing and arranged up and down into two rows. The positioning bracket is mounted to the back of the insulating housing, and top and bottom surfaces thereof define a plurality of positioning fillisters each penetrating therethrough along a front-to-rear direction. The soldering tails of the first terminals are positioned in the corresponding positioning fillisters opened in the top surface of the positioning bracket, and the soldering tails of the second terminals are positioned in the corresponding positioning fillisters opened in the bottom surface of the positioning bracket. As a result, the plug connector needs to be turned up and down to achieve the welding of the soldering tails in the positioning fillisters so that results in a complicated welding process. What's more, one of the second terminals is only acted as an artistic terminal for ornamenting the plug connector, with no need for welding the soldering tail thereof in the positioning fillister. As a result, it is apt to cause soldering the wrong soldering tail of the artistic terminal, and further result in an unqualified plug connector.

### SUMMARY OF THE INVENTION

Accordingly, an object of the present invention is to provide a plug connector. The plug connector includes an insulating housing having a base and a tongue protruding forward from a front of the base. A top of the tongue defines a mating groove penetrating through a front thereof. A plurality of terminal slots is defined in a bottom inner side of the mating groove and each extends along a front-to-rear direction to penetrate through the base. A plurality of terminals includes a plurality of first terminals, a plurality of second terminals and an artistic terminal of which each is inserted forward in one terminal slot of the insulating housing and has a contacting portion protruding upward into the mating groove. The first terminal has a first soldering portion bending sideward and then extending rearward at a rear end thereof. The second terminal has a second soldering portion bending towards one side opposite to the first soldering portion and then extending rearward at a rear end thereof. The first soldering portions and the second soldering portions stretch behind the base and are apart arranged in a substantial same horizontal plane. A positioning bracket is mounted to a rear of the base and has a base body with a plurality of positioning fillisters apart opened in a top surface thereof. Each positioning fillister further penetrates through the base body along a front-to-rear direction. The first soldering portions of the first terminals and the second soldering portions of the second terminals are positioned in the positioning fillisters respectively. A metal shell is curved from a metal plate to show a hollow barrel shape and sheathes the tongue of the insulating housing.

As described above, the first soldering portions of the first terminals and the second soldering portions of the second terminals are apart arranged in the substantial same horizontal plane and positioned in the positioning fillisters respectively apart opened in the top surface of the base body. So, the plug connector doesn't need to be turned up and down for welding the soldering portions in the positioning fillisters so that realizes an easy welding process. What's more, the artistic terminal has no soldering portion so that ensures an accurate welding operation of the first soldering portions and the second soldering portions and further ensures a good quality of the plug connector.

### BRIEF DESCRIPTION OF THE DRAWINGS

The present invention will be apparent to those skilled in the art by reading the following description thereof, with reference to the attached drawings, in which:

FIG. 1 is an assembled, perspective view of a plug connector in accordance with an embodiment of the present invention;

FIG. 2 is an exploded, perspective view of the plug connector shown in FIG. 1; and

FIG. 3 is a perspective view of an insulating housing of the plug connector shown in FIG. 1.

### DETAILED DESCRIPTION OF THE EMBODIMENT

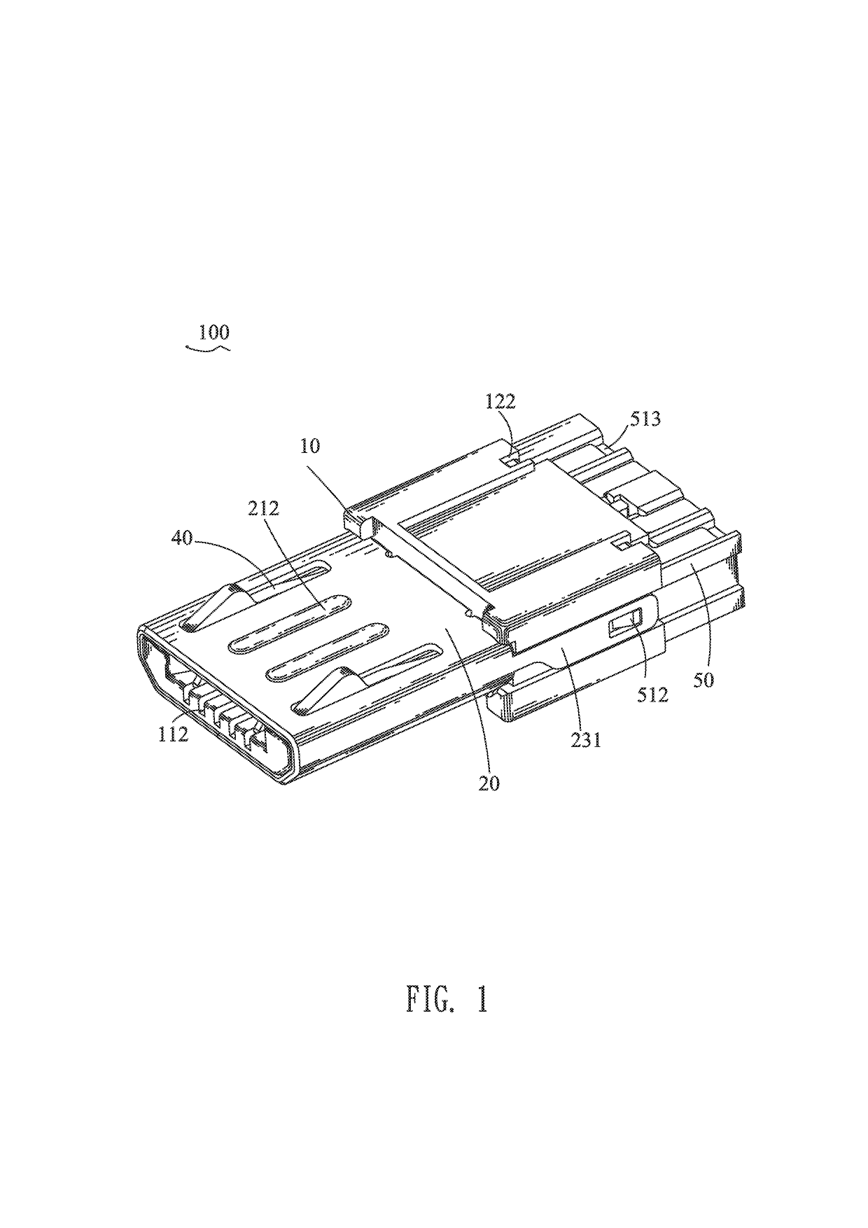

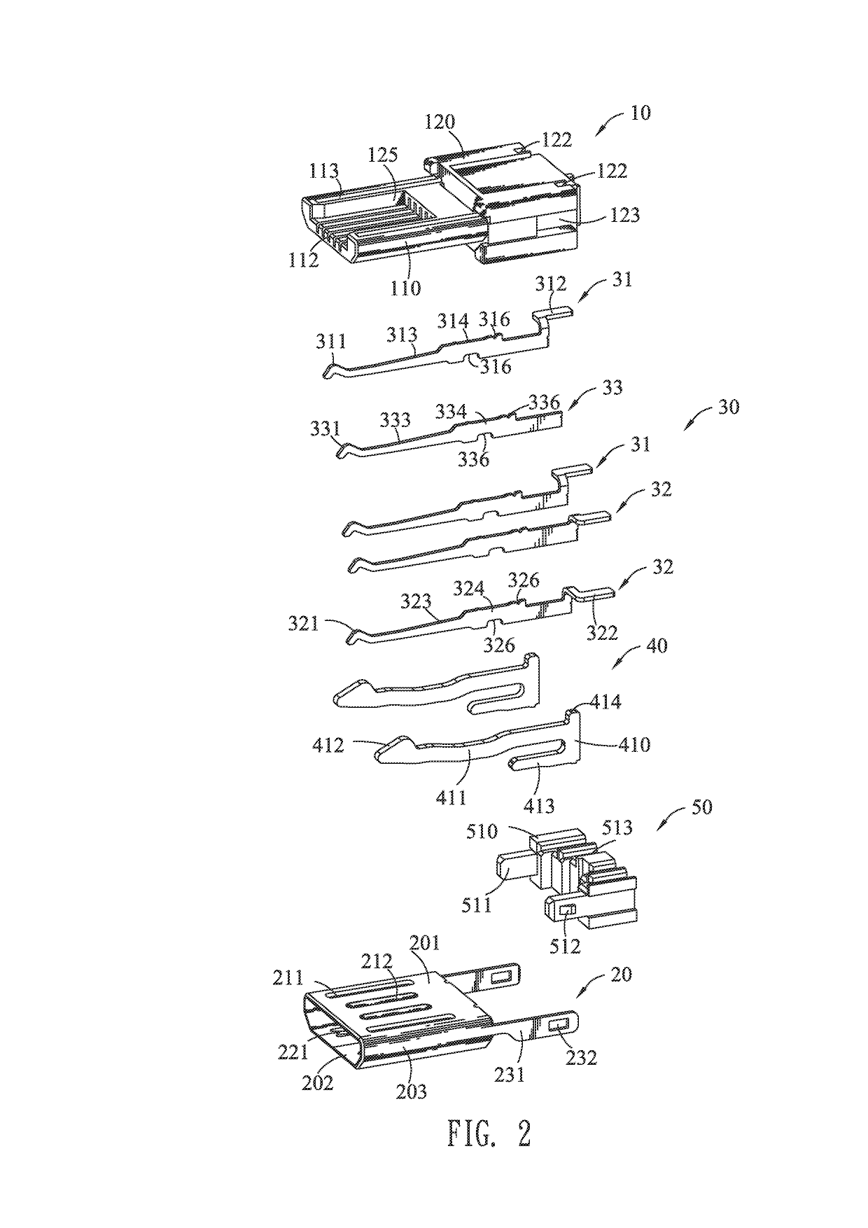

Referring to the drawings in greater detail, and first to FIGS. 1-2, an embodiment of the invention is embodied in a plug connector 100. The plug connector 100 includes an insulating housing 10, a plurality of terminals 30, two latches 40, a positioning bracket 50 and a metal shell 20.

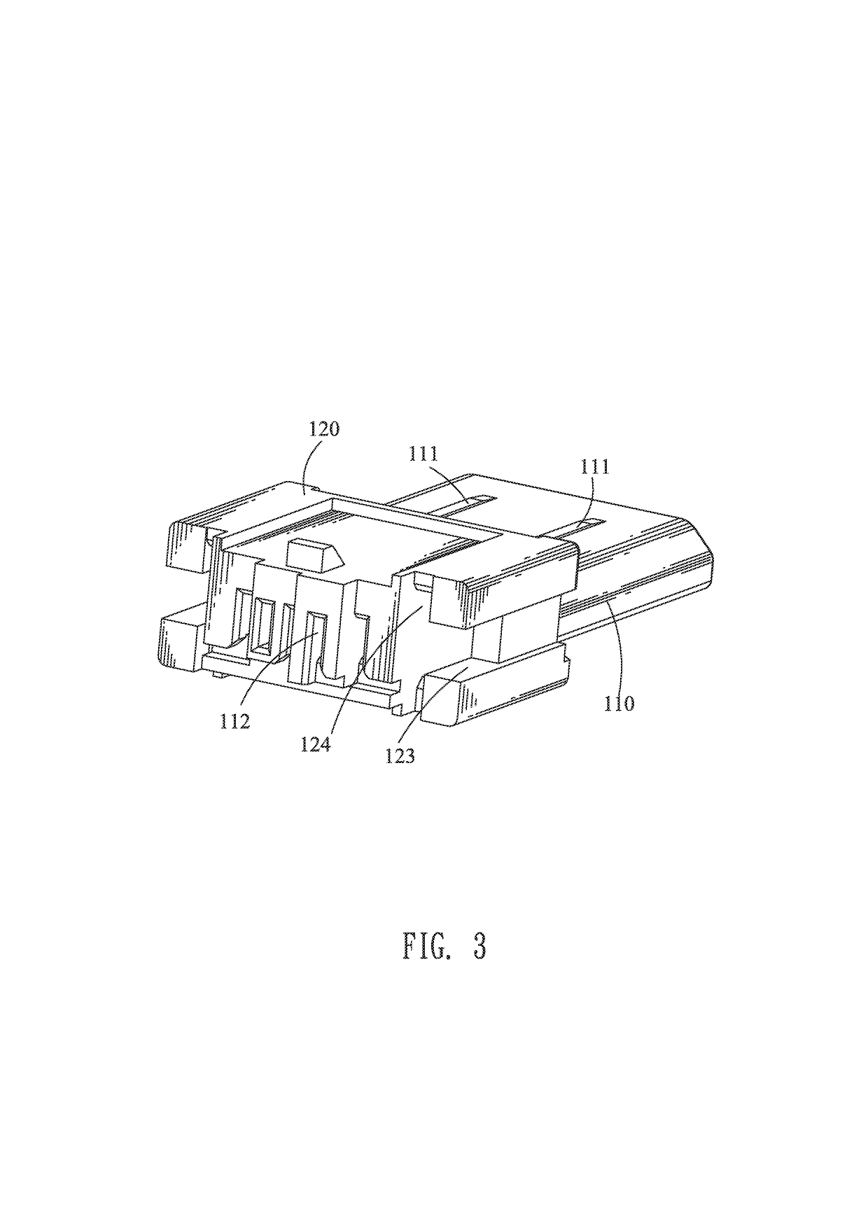

With reference to FIGS. 1-3, the insulating housing 10 has a base 120 and a tongue 110 protruding forward from a front of the base 120. A top of the tongue 110 defines a mating groove 125 penetrating through a front thereof. A plurality of terminal slots 112 is defined in a bottom inner side of the mating groove 125 and each extends along a front-to-rear direction to penetrate through the base 120. A pair of holding cavities 123 is opened in two opposite outer sides of a rear of the base 120 and penetrates rearward through the base 120. The rear of the base 120 defines a pair of inserting slots 113 located beside two outmost terminal slots 112 and each further extending forward into the tongue 110. The inserting slots 113 penetrate through the top of the tongue 110. The rear of the base 120 further defines a pair of inserting fillisters 124 located under the inserting slots 113 respectively. A rear end of each inserting slot 113 is spread upward to define a fastening gap 122. A bottom side of the tongue 110 protrudes downward to form two fastening ribs 111 each extending along the front-to-rear direction.

With reference to FIG. 1 and FIG. 2, the terminals 30 include a plurality of first terminals 31, a plurality of second terminals 32 and an artistic terminal 33 of which each is inserted forward in one terminal slot 112 of the insulating housing 10 and has a contacting portion labeled with 311, 321, 331 respectively and protruding upward into the mating groove 125. The first terminal 31 has a first soldering portion 312 bending sideward and then extending rearward at a rear end thereof. The second terminal 32 has a second soldering portion 322 bending towards one side opposite to the first soldering portion 312 and then extending rearward at a rear end thereof. The first soldering portions 312 and the second soldering portions 322 stretch behind the base 120 and are apart arranged in a substantial same horizontal plane. Each of the first terminals 31, the second terminals 32 and the artistic terminal 33 has an upright board-shaped fastening portion labeled with 314, 324, 334 respectively and fixed in a rear of the corresponding terminal slot 112. Front ends of the fastening portions 314, 324, 334 extend forward to form elastic arms 313, 323, 333 located in fronts of the corresponding terminal slots 112. Front ends of the elastic arms 313, 323,333 are arched upward to form the contacting portions 311, 312, 313. The first soldering portions 312 and the second soldering portions 322 are curvedly formed from top edges of rear ends of the corresponding fastening portions 314, 324 of the first terminals 31 and the second terminals 32 respectively, and each shows a flat board shape. Top and bottom edges of the fastening portions 314, 324, 334 define a plurality of locking portions 316, 326, 336 snapped in inner sides of the rears of the corresponding terminal slots 112 to secure the first terminals 31, the second terminals 32 and the artistic terminal 33 in the insulating housing 10.

With reference to FIG. 1 and FIG. 2, each of the latches 40 has a connecting arm 410 of which a top end extends forward to form a resilient arm 411 and a bottom end extends forward to form an inserting arm 413. Rear ends of the inserting slot 113 and the corresponding inserting fillister 124 are connected together to receive the connecting arm 410. The inserting arm 413 is inserted in the inserting fillister 124, and the resilient arm 411 is inserted in the inserting slot 113. The resilient arm 411 slightly inclines upward and a free end thereof protrudes upward to form a locking barb 412 elastically projecting upward out of the inserting slot 113. The top end of the connecting arm 410 of the latch 40 protrudes upward to form a fastening ear 414 buckled in the fastening gap 122.

With reference to FIG. 1 and FIG. 2, the positioning bracket 50 is mounted to the rear of the base 120 and has a base body 510 with a plurality of positioning fillisters 513 apart opened in a top surface thereof. Each positioning fillister 513 further penetrates through the base body 510 along a front-to-rear direction. The first soldering portions 312 of the first terminals 31 and the second soldering portions 322 of the second terminals 32 are positioned in the positioning fillisters 513 respectively. Two ends of a front side of the base body 510 protrude forward to form a pair of holding arms 511 with two wedges 512 oppositely protruding on two opposite outer sides thereof. The holding arms 511 are inserted forward in the holding cavities 123 to attach the base body 510 onto a back of the base 120.

With reference to FIG. 1 and FIG. 2, the metal shell 20 is curved from a metal plate to show a hollow barrel shape and sheathes the tongue 110 of the insulating housing 10. The metal shell 20 has a pair of side plates 203 of which each is elongated rearward to form a holding plate 231 with a buckling hole 232 opened in a rear thereof. The holding plates 231 are embedded rearward in the two opposite outer sides of the base 120 to buckle the wedges 512 in the corresponding buckling holes 232 so as to secure the metal shell 20, the positioning bracket 50 and the insulating housing 10 together. The metal shell 20 has a top plate 201 of which two opposite side edges extend downward to form the pair of side plates 203. Two bottom plates 202 extend towards each other from two bottom edges of the side plates 203 and are wedged together. The top plate 201 of the metal shell 20 protrudes upward to form two strengthening ribs 212 each extending along the front-to-rear direction. A pair of open slots 211 is opened in the top plate 201 and corresponds to the inserting slots 113 of the insulating housing 10 for exposing the locking barbs 412 out therefrom. Each of the bottom plates 202 is punched downward to form a buckling arm 221. The fastening ribs 111 of the insulating housing 10 interfere with inner sides of the bottom plates 202 respectively to ensure an assembly of the metal shell 20 and the tongue 110.

As described above, the first soldering portions 312 of the first terminals 31 and the second soldering portions 322 of the second terminals 32 are apart arranged in the substantial same horizontal plane and positioned in the positioning fillisters 513 apart opened in the top surface of the base body 510. So, the plug connector 100 doesn't need to be turned up and down for welding the soldering portions 312, 322 in the positioning fillisters 513 so that realizes an easy welding process. What's more, the artistic terminal 33 has no soldering portion so that ensures an accurate welding operation of the first soldering portions 312 and the second soldering portions 322 and further ensures a good quality of the plug connector 100.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A plug connector, comprising:
an insulating housing having a base and a tongue protruding forward from a front of the base, a top of the tongue defining a mating groove penetrating through a front thereof, a plurality of terminal slots being defined in a bottom inner side of the mating groove and each extending along a front-to-rear direction to penetrate through the base;
a plurality of terminals including a plurality of first terminals, a plurality of second terminals and an artistic terminal of which each is inserted forward in one terminal slot of the insulating housing and has a contacting portion protruding upward into the mating groove, the first terminal having a first soldering portion bending sideward and then extending rearward at a rear end thereof, the second terminal having a second soldering portion bending towards one side opposite to the first soldering portion and then extending rearward at a rear end thereof, the first soldering portions and the second soldering portions stretching behind the base and being apart arranged in a substantial same horizontal plane;
a positioning bracket mounted to a rear of the base and having a base body with a plurality of positioning fillisters apart opened in a top surface thereof, each positioning fillister further penetrating through the base body along a front-to-rear direction, the first soldering portions of the first terminals and the second soldering portions of the second terminals being positioned in the positioning fillisters respectively; and
a metal shell curved from a metal plate to show a hollow barrel shape and sheathing the tongue of the insulating housing.

2. The plug connector as claimed in claim 1, wherein each of the first terminals, the second terminals and the artistic terminal has an upright board-shaped fastening portion fixed in a rear of the corresponding terminal slot, a front end of the fastening portion extends forward to form an elastic arm located in a front of the terminal slot, a front end of the elastic arm is arched upward to form the contacting portion, the first soldering portions and the second soldering portions are curvedly formed from top edges of rear ends of the corresponding fastening portions of the first terminals and the second terminals respectively, and each shows a flat board shape.

3. The plug connector as claimed in claim 2, wherein top and bottom edges of each fastening portion define a plurality of locking portions snapped in inner sides of the rear of the corresponding terminal slot to secure the first terminals, the second terminals and the artistic terminal in the insulating housing.

4. The plug connector as claimed in claim 1, wherein a pair of holding cavities is opened in two opposite outer sides of the rear of the base and penetrates rearward through the base, two ends of a front side of the base body protrude forward to form a pair of holding arms with two wedges oppositely protruding on two opposite outer sides thereof, the metal shell has a pair of side plates of which each is elongated rearward to form a holding plate with a buckling hole opened in a rear thereof, the holding arms are inserted forward in the holding cavities to attach the base body onto a back of the base, the holding plates are embedded rearward in the two opposite outer sides of the base to buckle the wedges in the corresponding buckling holes so as to secure the metal shell, the positioning bracket and the insulating housing together.

5. The plug connector as claimed in claim 4, wherein the metal shell has a top plate of which two opposite side edges extend downward to form the pair of side plates, two bottom plates extend towards each other from two bottom edges of the side plates and are wedged together, a bottom side of the tongue protrudes downward to form two fastening ribs each extending along the front-to-rear direction and interfering with inner sides of the bottom plates respectively to ensure an assembly of the metal shell and the tongue.

6. The plug connector as claimed in claim 5, wherein the top plate of the metal shell protrudes upward to form two strengthening ribs each extending along the front-to-rear direction, each of the bottom plates are punched downward to form a buckling arm.

7. The plug connector as claimed in claim 1, wherein the rear of the base defines a pair of inserting slots located beside two outmost terminal slots and each further extending forward into the tongue, and a pair of inserting fillisters located under the inserting slots respectively, the inserting slots penetrate through the top of the tongue, the metal shell has a top plate with a pair of open slots opened therein and corresponding to the inserting slots, the plug connector further includes two latches each having a connecting arm of which a top end extends forward to form a resilient arm and a bottom end extends forward to form an inserting arm, rear ends of the inserting slot and the corresponding inserting fillister are connected together to receive the connecting arm, the inserting arm is inserted in the inserting fillister, and the resilient arm is inserted in the inserting slot, the resilient arm slightly inclines upward and a free end thereof protrudes upward to form a locking barb elastically projecting upward out of the inserting slot and the open slot.

8. The plug connector as claimed in claim 7, wherein the rear end of each inserting slot is further spread upward to define a fastening gap, the top end of the connecting arm of the latch protrudes upward to form a fastening ear buckled in the fastening gap.
